(19) United States
(12) Patent Application Publication
(10) Pub. No.: US 2005/0166832 A1
(43) Pub. Date: Aug. 4, 2005

(54) Page indicator

(75) Inventor: Timothy M. Roewe, Washington, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: DAC, Inc.

(21) Appl. No.: 10/770,118

(22) Filed: Feb. 2, 2004

(51) Int. Cl. B42D 9/00

(52) U.S. Cl. 116/234

(57) ABSTRACT

A page indicator of the present invention marks a page of a book or the like. The page indicator is received on a free corner of the page and facilitates grasping the page from either of the adjacent page edge margins at the corner. The page indicator is capable of presenting promotional or other information in a position which is readily observed by the reader upon opening to the page marked.

### BACKGROUND OF THE INVENTION

This invention relates generally to bookmarks and more particularly to a page indicator for marking a page in a book or other publication.

Readers of books or other publications frequently use a bookmark to indicate the last page read during a reading session and the proper page to start during a subsequent reading session. Also, users of reference publications such as dictionaries or encyclopedias frequently use a bookmark to mark a page of the publication that has important information requiring frequent reference. It is important that such bookmarks be securely fastened to the page so that the reader's place in the book or publication is not lost by the bookmark inadvertently falling out of the book. Also, the bookmark should be readily visible to the user to indicate the proper page being indicated. The bookmark should be easy to grasp so that the book or other publication can quickly be turned to the proper page without the bookmark becoming detached from the page.

Various bookmarks exist that are designed to attach to the top edge margin or side edge margin of a page. Some conventional bookmarks are designed to attach to a top edge margin or a side edge margin of the page. These existing designs are difficult to grasp and are not easily seen by a user. Further, the page of a book may be easily and quickly turned by grasping the page near the free edge or corner, rather than the top or side edge margin of the page. Existing bookmark designs do not clearly indicate the corner of the page being marked so that the reader may quickly grasp the corner of the desired page to turn the book to the desired location.

Other bookmarks may be mounted near the corner of a book. However, these existing designs do not clearly mark the edge margin of the corner of the page and are not securely attached to the page to prevent the bookmark from coming loose and the proper page indication being lost. Therefore, a need exists for a page indicator for a book or other publication that can be securely attached to a page of the book to clearly indicate to a user the corner of the desired page so that the place in the book can be quickly and easily located.

### SUMMARY OF THE INVENTION

Among the several objects of this invention may be noted the provision of a page indicator that can be securely attached to a corner of a page; the provision of such an indicator that clearly identifies a page; and the provision of such an indicator which can overlay a portion of the page to provide a display area visible to a reader of the page.

A page indicator of the present invention identifies a page having generally perpendicular first and second free edge margins forming a corner of the page. The page indicator generally comprises a panel having a front surface and a back surface. A flap is connected to the panel and moveable between a first position wherein the flap is substantially coplanar with the panel and a page receiving position wherein the flap is pivoted away from the panel to provide an opening for receiving the corner of the page. The panel has a first edge margin and a second edge margin that are substantially perpendicular. The first and second edge margins of the panel are shaped and arranged relative to the flap such that when the flap receives the page corner, the first panel edge margin projects from and is generally parallel to the first free edge margin of the page and the second panel edge margin projects from and is generally parallel to the second free edge margin of the page whereby the page indicator may be engaged adjacent either free edge margin of the page for opening to the page.

In another aspect of the invention, the page indicator comprises a panel having a front surface and a back surface and a first edge margin and a second edge margin. A flap is connected to the panel and moveable between a first position wherein the flap is substantially coplanar with the panel and a page receiving position wherein the flap is pivoted away from the panel to provide an opening for receiving the corner of the page. The flap having a hinge axis for movement of the flap away from the panel and a centerline passing through the hinge axis. The flap is arranged relative to the first and second edge margins of the panel such that the centerline of the flap is non-perpendicular to the first and second edge margins of the panel.

Other objects and features of the present invention will be in part apparent and in part pointed out hereinafter.

### BRIEF DESCRIPTION OF THE DRAWINGS

FIG. 1 is a front perspective of a page indicator of the present invention shown attached to a page of a book;

FIG. 2 is a front plan view of the page indicator removed from the book;

FIG. 3 is a back perspective of the page indicator;

FIG. 4 is a front plan view of the page indicator removed from the page of the book prior to attachment of the indicator;

FIG. 5 is a detail view of the page indicator attached to the page; and

FIG. 6 is a back plan view of the page indicator attached to the page;

Corresponding parts are designated by corresponding reference numbers throughout the drawings.

### DESCRIPTION OF PREFERRED EMBODIMENTS

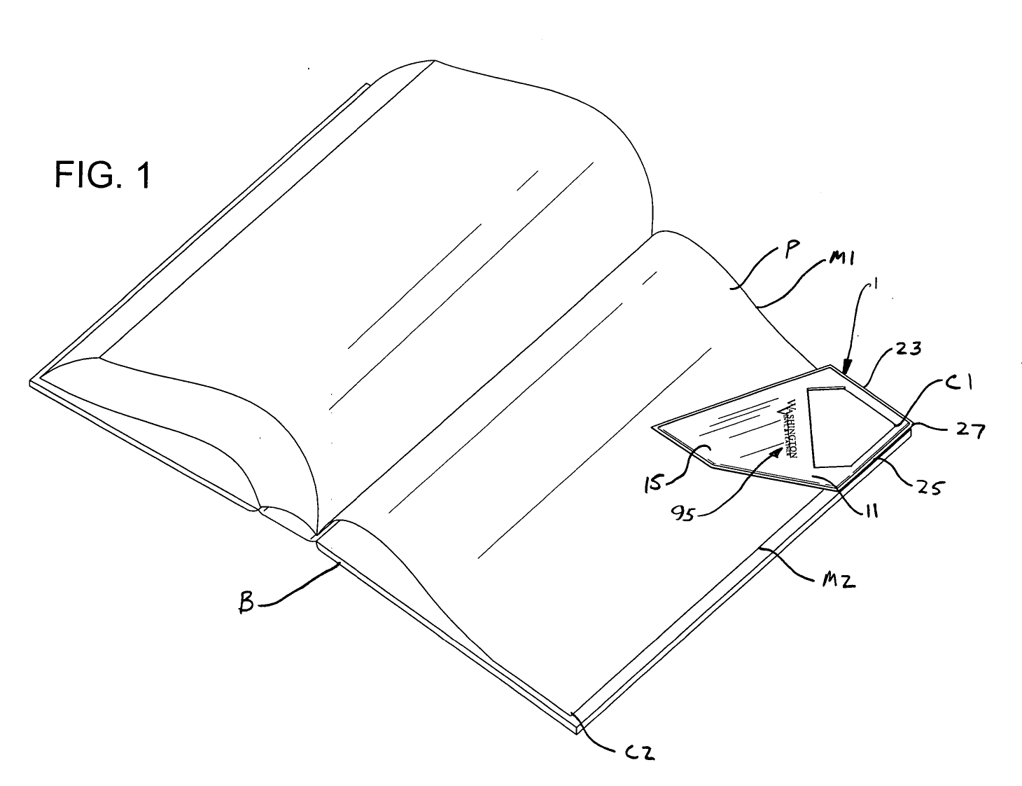

Referring to FIG. 1, a page indicator of the present invention is designated in its entirety by the reference numeral 1. The indicator is shown attached to a page P of a book B to remind a reader of the location of a page of interest in the book such as a starting page in subsequent reading session or a page that may contain important information requiring ready-reference by the user. In one embodiment, the page indicator 1 is used for identifying a page having a perpendicular first (top) free edge margin M1 and second (side) free edge margin M2 that meet at a top corner C1 of the page P. Alternatively, the page indicator 1 of the present invention could be attached to a bottom corner C2 of the page P without departing from the scope of this invention. Further, it will be understood that the page indicator 1 can be used on pages of publications other than books (e.g., magazines, brochures, catalogs, or other written works) without departing from the scope of this invention.

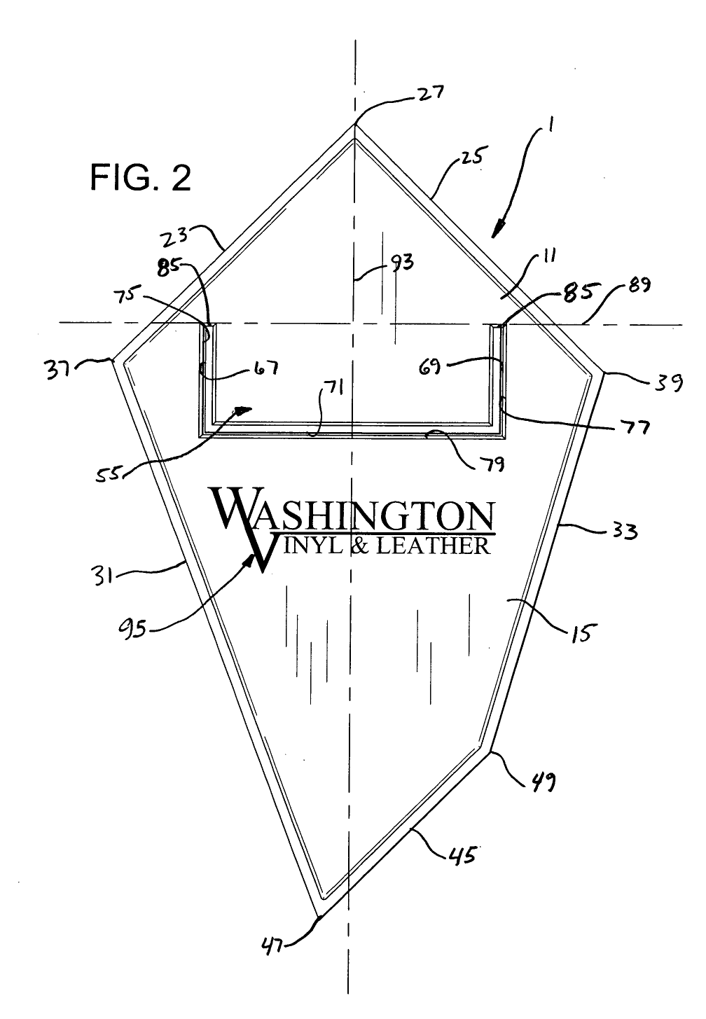

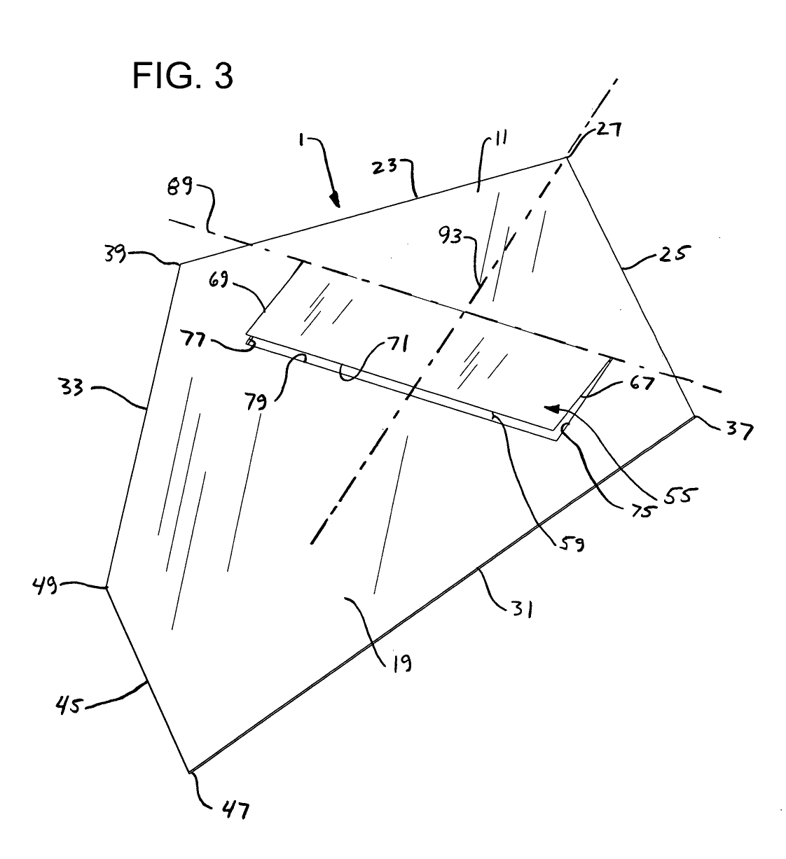

In the illustrated embodiment, the page indicator 1 comprises a generally planar panel 11 having a front surface 15 and a back surface 19 and a five-sided irregular polygon shape. The panel 11 is shown as solid, but may be apertured. It will be understood that the panel 11 may have various other regular or irregular shapes without departing from the scope of the present invention. As shown in FIGS. 2 and 3, the panel 11 includes a first edge margin 23 and a second edge margin 25 that are substantially perpendicular to form a 90-degree corner 27 of the panel that is generally adjacent the corner C1 (FIG. 1) of the page P. A third edge margin 31 and fourth edge margin 33 of the panel 11 intersect respective first and second edge margins 23, 25 at obtuse angles to form respective corners 37, 39 of the page indicator 1. The fifth edge margin 45 is substantially parallel to the first edge margin 23 and intersects the third edge margin 31 and fourth edge margin 33 at respective corners 47, 49 to form the closed polygonal shape of the panel 11.

In the illustrated embodiment, the page indicator 1 has a flap, generally indicated 55, connected to the panel 11 that is moveable between a first position (FIG. 2) where the flap is substantially coplanar with the panel and a second (page receiving) position (FIG. 3) where the flap is pivoted away from the panel to provide an opening 59 for receiving the corner C1 of the page P. The flap 55 is generally rectangular and is separated from the panel 11 by a notch or slit such that the panel and the flap have opposed edge margins. It is to be understood that the flap 55 may have shapes other than rectangular, and need not be a solid piece.

As shown in FIG. 2, the flap 55 is disposed within a periphery of the panel 11 and has first and second parallel edge margins, designated 67 and 69, respectively, and a third edge margin 71 substantially perpendicular to the first and second edge margins. The panel 11 has three corresponding edge margins 75, 77, 79 that are generally adjacent and spaced apart from respective flap edge margins 67, 69, 71. The opposed edge margins of the panel 11 and flap 55 are joined at two junctions 85 between the panel and the flap. The junctions 85 are formed generally adjacent the ends of the first and second parallel edge margins 67, 69 of the flap 55. As shown in FIG. 2, the junctions 85 are substantially aligned along a hinge axis 89 of the flap. The hinge axis 89 and the first, second and third edge margins 67, 69, 71 of the flap 55 define the four sides of the generally rectangular flap. The hinge axis 89 defines a pivot axis between the flap 55 and the panel 11 allowing the flap to pivot downward to the page receiving position (FIG. 3) where the flap is out of planar registration with the panel to create the opening 59 in the panel for receiving the corner C1 of the page P. Alternatively, the flap 55 could pivot upward relative to the panel 11 to create the opening 59 between the flap and the panel for receiving the corner C1 (FIG. 1) of the page P without departing from the scope of this invention.

As seen in FIG. 2, the flap 55 has a centerline 93 that is generally perpendicular to the hinge axis 89 and passes through the hinge axis to intersect the first edge margin 23 and second edge margin 25 of the panel 11 at the corner 27 of the indicator 1. The centerline 93 generally bisects the flap 55 in the illustrated embodiment. The flap 55 is arranged such that the centerline 93 is generally parallel to the first edge margin 67 and second edge margin 69 of the flap and is non-perpendicular to the first edge margin 23 and second edge margin 25 of the panel 11. In the illustrated embodiment, the centerline 93 of the flap 55 is aligned to intersect the corner 27 of the panel 11 to form acute (45°) angles with respect to the first and second edge margins 23, 25. It will be understood that the flap 55 may be offset from the corner 27 of the panel 11 such that the centerline 93 of the flap 55 intersects one or the other of the first and second edge margins 23, 25 of the panel. Also, although less preferred, the centerline 93 of the flap 55 and the first and second edge margins 23, 25 of the panel 11 may be oriented such that the intersecting angle of the flap centerline with one or both of the edge margins is obtuse rather than acute.

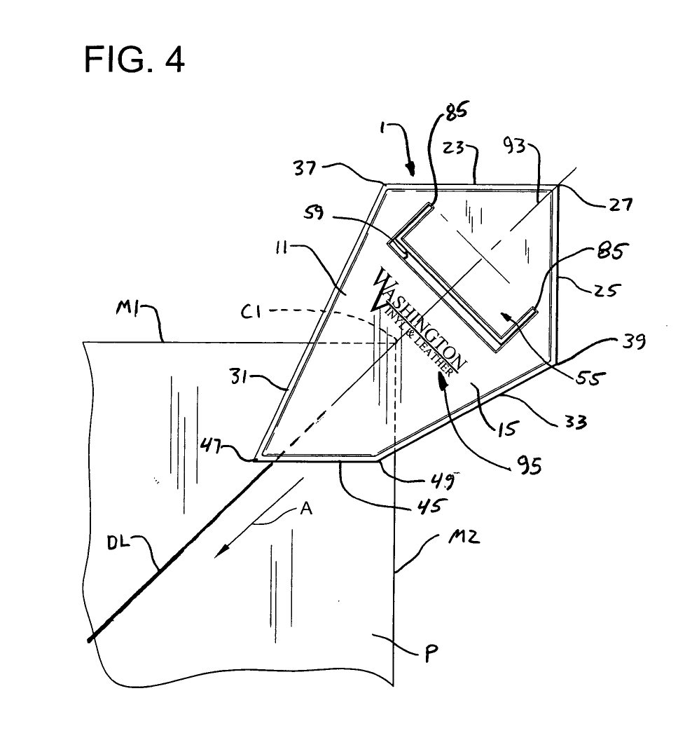

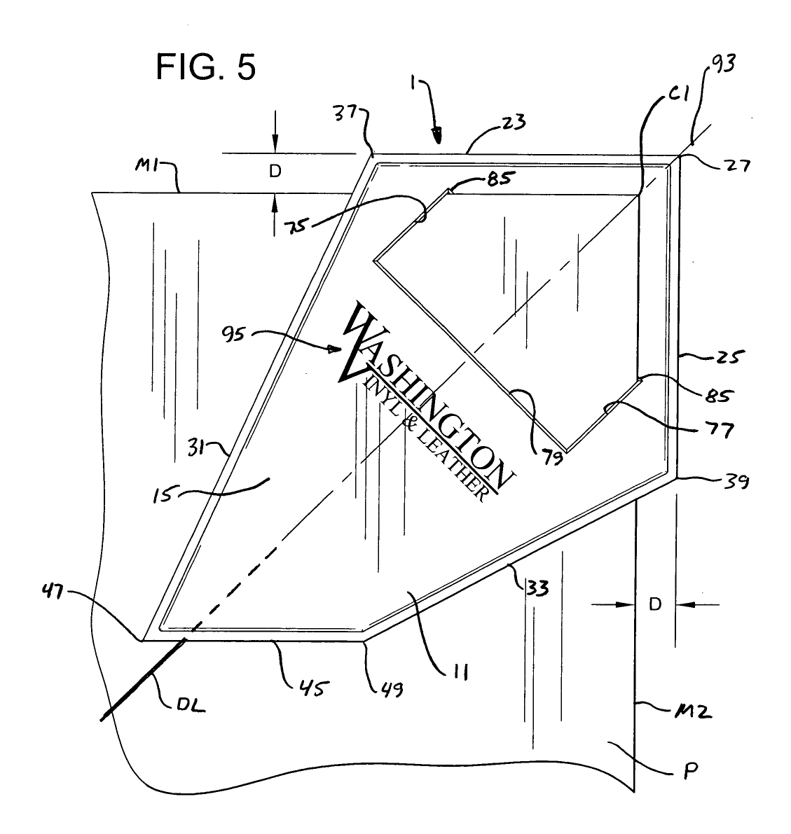

In use, the indicator 1 is mounted on a page P such that the corner C1 of the page is received through the opening 59 between the flap 55 and the panel 11. As shown in FIG. 4, the indicator 1 is positioned near the corner C1 of the page P and the flap 55 is pivoted downward to a page receiving position so that the opening 59 between the flap and the panel 11 is positioned for receiving the corner of the page. The indicator 1 is moved in the direction of arrow A to position the indicator on the page P so that the corner C1 of the page is received through the opening 59 between the flap 55 and the panel 11. The indicator 1 is secured on the page P by moving the indicator in the direction of arrow A until each free edge margin M1, M2 of the page contacts a respective junction 85 between the opposed edge margins 67, 75 and 69, 77 of the flap 55 and the panel 11. The wedging action of the page P at the junctions 85 between the flap 55 and the panel 11 creates a page holding force that tends to keep the indicator 1 attached to the page. Upon attachment of the indicator 1 to the page P, as shown in FIG. 5, the corner 27 of the indicator is generally aligned with a diagonal line DL of the page passing through the corner C1 of the page.

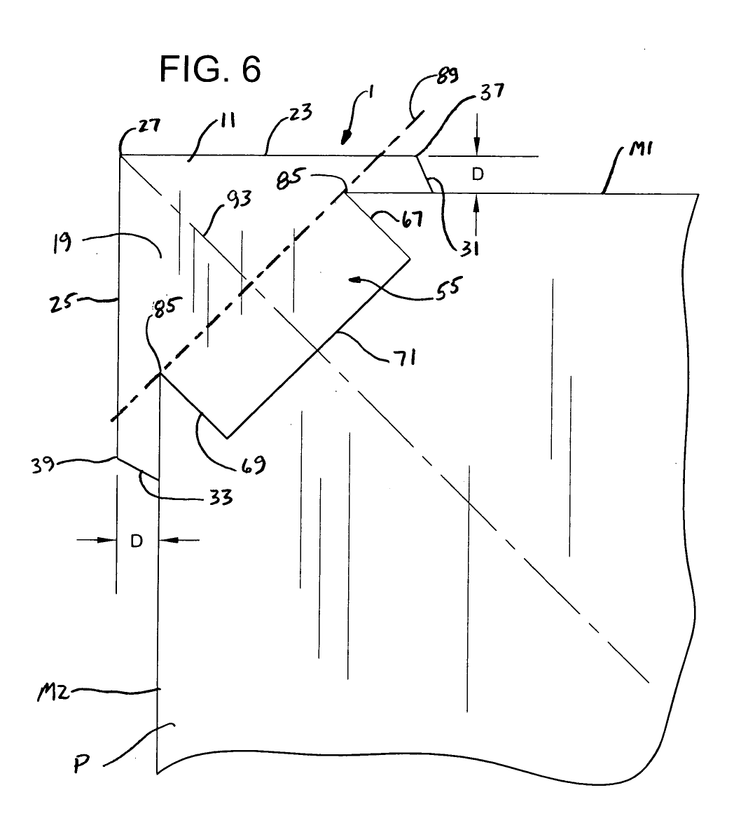

In the illustrated embodiment, the first edge margin 23 and second edge margin 25 of the panel 11 are shaped and arranged relative to the flap 55 such that when the flap receives the page corner C1, the first panel edge margin projects from and is generally parallel to the first free edge margin M1 of the page P and the second panel edge margin projects from and is generally parallel to the second free edge margin M2 of the page. As shown in FIGS. 5 and 6, the first and second panel edge margins 23, 25 extend from respective page free edge margins M1, M2 by at least a distance D so that the indicator 1 can be easily identified when the book B is closed. Further, the page indicator 1 may be engaged for opening the book B by grasping either of the first and second panel edge margins 23, 25 that project past the first and second free edge margin M1, M2 of the page P. In one embodiment the distance D is at least about ⅛ of an inch to facilitate grasping of the panel edge margins 23, 25. It will be understood that the indicator 1 may be configured such that the panel edge margins 23, 25 project outward from the page P by more or less than ⅛ of an inch without departing from the scope of this invention.

In the attached position of the indicator 1, the corner C1 of the page P is spaced in from the corner 27 of the indicator and the back surface of the page generally near the page corner is in contact with the front surface of the flap 55 so that the portion of the front surface of the page near the page corner is exposed to the reader of the book B. The back surface 19 of the panel 11 at the lower portion of the panel contacts the front surface of the page P such the lower portion of the panel overlays the page and the lower portion of the panel is visible to the reader of the book B. The visibility of the lower portion of the panel 11 makes the indicator of the present invention useful in displaying advertising, generally indicated 95, on the front surface 15 of the lower portion of the panel that is frequently viewed by a reader of the book. The advertising 95 could be any information such as a logo or slogan of a company that is desired to be frequently seen by a reader of the book. Also, the advertising 95 could be otherwise located on the indicator 1 (e.g., on the panel 55) for viewing by a reader of the book, or the advertising 95 could be omitted from the indicator without departing from the scope of this invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

1. A page indicator for identifying a page having generally perpendicular first and second free edge margins forming a corner of the page, the page indicator comprising:
a panel having a front surface and a back surface;
a flap connected to the panel and moveable between a first position wherein said flap is substantially coplanar with said panel and a page receiving position wherein said flap is pivoted away from said panel to provide an opening for receiving said corner of a page,
the panel having a first edge margin and a second edge margin that are substantially perpendicular, said first and second edge margins of the panel being shaped and arranged relative to the flap such that when the flap receives the page corner, the first panel edge margin projects from and is generally parallel to the first free edge margin of the page and the second panel edge margin projects from and is generally parallel to the second free edge margin of the page whereby the page indicator may be engaged adjacent either free edge margin of the page for opening to the page.

2. The page indicator set forth in claim 1 wherein said first and second panel edge margins are sized to extend from respective page edge margins by at least about ⅛ of an inch.

3. The page indicator set forth in claim 1 wherein said first and second edge margins of the panel define a corner of the indicator, the corner being generally aligned with the corner of the page and with a diagonal line of the page passing through the corner of the page upon insertion of said page corner into the opening.

4. The page indicator set forth in claim 1 wherein the back surface of the panel is disposed for contacting with a front surface of the page and a front surface of the flap is disposed for contacting a back surface of the page such that a portion of the panel overlays said page such that the front surface of the panel is visible to a reader of the page.

5. The page indicator set forth in claim 1 wherein said flap is disposed within a periphery of the panel such that said opening is defined between the flap and panel, the panel and flap having opposed edges arranged for wedging portions of the page therebetween for holding the page indicator on the page.

6. The page indicator set forth in claim 5 wherein said opposed edges of the panel and the flap meet at least one junction between the flap and the panel, the at least one junction being adapted to engage one of the adjacent page edge margins upon insertion of said page corner into the opening.

7. The page indicator set forth in claim 6 wherein said opposed edges of the panel and the flap meet at two junctions within the periphery of the panel, each junction being adapted to engage a respective one of the page edge margins.

8. The page indicator set forth in claim 1 wherein said panel is made at least in part of leather.

9. The page indicator set forth in claim 1 wherein said panel is made at least in part of vinyl.

10. A page indicator for identifying a page having generally perpendicular first and second free edge margins forming a corner of the page, the page indicator comprising:
a panel having a front surface and a back surface and a first edge margin and a second edge margin;
a flap connected to the panel and moveable between a first position wherein said flap is substantially coplanar with said panel and a page receiving position wherein said flap is pivoted away from said panel to provide an opening for receiving said corner of the page, the flap having a hinge axis for movement of the flap away from the panel and a centerline passing through the hinge axis,
the flap being arranged relative to the first and second edge margins of the panel such that said centerline of the flap is non-perpendicular to the first and second edge margins of the panel.

11. The page indicator set forth in claim 10 wherein said first and second edge margins of the panel define a corner of the indicator, the corner being located generally on a diagonal line of the page passing through the corner of the page upon insertion of said page corner into the opening.

12. The page indicator set forth in claim 11 wherein said flap centerline and said corner of the indicator are generally aligned.

13. The page indicator set forth in claim 10 wherein said first and second panel edge margins are sized to extend from respective page edge margins by at least about ⅛ of an inch.

14. The page indicator set forth in claim 10 wherein the back surface of the panel is disposed for contacting with a front surface of the page and a front surface of the flap is disposed for contacting a back surface of the page such that a portion of the panel overlays said page such that the front surface of the panel is visible to a reader of the page.

15. The page indicator set forth in claim 10 wherein said flap is disposed within a periphery of the panel such that said opening is defined between the flap and panel, the panel and flap having opposed edges arranged for wedging portions of the page therebetween for holding the page indicator on the page.

16. The page indicator set forth in claim 5 wherein said opposed edges of the panel and the flap meet at least one junction between the flap and the panel, the at least one junction being adapted to engage one of the adjacent page edge margins upon insertion of said page corner into the opening.

17. The page indicator set forth in claim 16 wherein said opposed edges of the panel and the flap meet at two junctions within a periphery of the panel, each junction being adapted to engage a respective one of the page edge margins.

18. The page indicator set forth in claim 17 wherein said junctions are substantially aligned with said hinge axis of the flap.

19. The page indicator set forth in claim 10 wherein said panel is made at least in part of leather.

20. The page indicator set forth in claim 10 wherein said panel is made at least in part of vinyl.

21. The page indicator set forth in claim 1 wherein said flap is generally rectangular and is out of planar registration with the panel at said page receiving position.

22. The page indicator set forth in claim 1 wherein said flap has a hinge axis for movement of the flap away from the panel, the panel having a free edge margin spaced away from the hinge axis.

23. The page indicator set forth in claim 10 wherein said flap is generally rectangular and is out of planar registration with the panel at said page receiving position.

24. The page indicator set forth in claim 10 wherein said flap has a free edge margin spaced away from said hinge axis.
